(19) United States
(12) Patent Application Publication
(10) Pub. No.: US 2010/0123322 A1
(43) Pub. Date: May 20, 2010

(54) Modular folding/sliding latch system with self-locking and multi-functional operation

(76) Inventor: José Ramón Baragaño González, Guon (ES)

Correspondence Address: KLAUBER & JACKSON, 411 HACKENSACK AVENUE, HACKENSACK, NJ, 07601, US

(21) Appl. No.: 12/655,253

(22) Filed: Dec. 23, 2009

Related U.S. Application Data
(63) Continuation of application No. 11/895,799, filed on Aug. 27, 2007, now abandoned.
Application No. 11/895,799 is a continuation of application No. 11/358,703, filed on Feb. 21, 2006, now abandoned.
Application No. 11/358,703 is a continuation of application No. PCT/ES2004/000381, filed on Aug. 19, 2004.

(30) Foreign Application Priority Data
Aug. 21, 2003 (ES) P200301999
Jul. 14, 2004 (ES) P20041718

(51) Int. Cl. E05C 5/00; E05C 3/12; E05C 19/16; E05B 65/10

(52) U.S. Cl. 292/71

(57) ABSTRACT

A modular folding/sliding latch system with self-locking and multi-functional operation, for any type of access-control lock, from simple door retainers to mechanical, electrical and/or panic locks. The inventive system offers substantial advantages, namely: modular design, simple assembly, reduced size and easy installation. The structure comprises a frame or casing (60), and the tilting latch (5″) and the sliding shoe (62) are guided between the lateral walls of said frame. The transverse shafts of the latch and shoe move in respective grooves (58, 59), i.e., a longitudinal groove (58) for the shoe (62), and a curved groove (59) used to retract the latch (5″) when the system is being closed, and to retract same when the angle of rotation of the upper shaft is varied when the system is being opened, prior to releasing the lock. The latch (5″) is crenellated and the strike (68) comprises a corresponding anti-lever recess (69).

### OBJECT OF THE INVENTION

As stated in the title of this specification, this invention relates to a modular folding/sliding latch system with self-locking and multi-functional operation, which has been conceived and embodied in order to contribute considerable advantages compared to existing devices intended for that same task.

It has application to any type of access-control lock, from simple door retainers to mechanical, electrical and/or panic locks.

It is an object of the present invention to improve the folding/sliding latch system of the prior art, improving and contributing certain mechanisms which confer better use and greater reliability, both mechanical and magnetic, improving the construction process. Its structure offers a range of applications which objectify its broad operational spectrum or the opening of the latch is achieved by release, not by traction, with a greater utilisation of the magnetic principles and demultiplication of stresses and minimum consumption.

Certain changes of geometry are considered in some cases, which provide smoother sliding, using as guides the actual frames or walls of the box or casing in which they are housed, even making it possible to redistribute the complementary elements in different planes.

Another of the advantages introduced into the latch system that we are concerned with is the embodiment of an internal crenellation in the latch, which offers a particular system of concealable locking to any attempt at traction in forcing the lock.

A further object of the invention is to offer an elementary and reliable electromagnetic panic lock, by the simple application of the core and sliding shoe of the prior art, associating it with a lever (parrot beak).

The development of an elementary self-locking in an angular sliding double-folding catch, via some linkages, radically changes the concept of opening in emergency exit mechanisms, even having the same philosophy as the cited Patent, not forgetting the electromagnetic elements under inclined planes and the utilisation of permanent magnets as an alternative to conventional springs.

### PRIOR ART OF THE INVENTION

As is known the latch or catch is the most common emergent locking element in lock-making and is defined as: a short chamfered or bevelled lever which projects from the face. Under the action of a spring it is introduced when closing and automatically fits into the strike, thus ensuring constant immobilisation.

The opening is instigated by retracting the latch or catch by means of a knob, puller, handle or a key.

Self-locking is a complementary mechanism for preventing retraction by the frontal pushing of the latch; being able to be of the mechanical type, with levers or springs and therefore not exempt from friction and wear, being emergent and parallel to the latch, or integrated into it; this is the case of tubular latches which prevent manipulation by pushing their inclined plane from the outside, this latter being the classical system of using a card to open doors which have not been locked with a key.

In the type of electric lock that considers sliding of the latch or catch, either directly (electromagnet or motor) or via what is known as the load shaft, which is a second catch with greater tractive effort than the latch, the self-locking is usually associated with a series of levers for demultiplying the electrical potential.

Both in locks that generally have the self-locking emergent, or via the load shaft in electrical locks, their mechanical actuation is complex with levers and springs, and is not exempt from friction, and is very critical since it depends on the gap existing between the plate at the front of the lock and that of the strike, with its efficiency diminishing as the clearance between the door and the frame increases.

Spanish patent application No. 200200790 reported a latch of the defined type, located inside a casing and in which there were four fundamental elements involved for its functioning: a latch itself, a sliding shoe, a retaining lever and a rocker arm. These four elements complemented by the operational form of retention that is selected from among those which conventionally exist, or specifically detailed in relation to the figures, provide new features in the field of lock-making.

The casing or box of the lock presents parallel guides in its base with the aim of improving the alignment and sliding of the shoe to which the rocker arm is connected, the box being closed by a cover and both by a front plate which serves as a guide for the emergent elements: latch and rocker arm.

The rocker arm is the element via which self-locking is achieved in order to prevent the retraction of the bolt once it is housed in the seat.

The latch is hollow, having a prismatic shape with its base in the form of a circular section and in its lower part and transversally it has a housing for coupling with the shoe, rotating in the manner of a hinge around a shaft, being furthermore assisted by a recovery spring. It has some tangential bevels in its sectorial lateral walls, which do not reach the point of cutting the vertices of the upper part, thereby forming stopping means delimiting the emergence of the latch. Laterally it has some housings, one on each side, in one of which will act a retaining lever which is oscillating in order to perform its function. The housings on both sides are provided in such a way that either one can be used depending on the construction of the lock in which the said retaining lever is to be fitted.

The sliding shoe has some corresponding parallel grooves for its correct sliding in the base of the casing, and in its upper part it has a space for housing the folding of the latch that rotates in it. Its rear part includes a projection with a hole for the passage of a guide shaft on which is mounted the compression spring that maintains the shoe and therefore the latch in the emergent position with respect to the front, in the rest state.

The retaining lever is an element that oscillates around an end shaft perpendicular to the base of the casing and which is fixed to the shoe, in such a way that in one rest position it remains supported against an emergent stop of the shoe in order for it to adopt a position longitudinal to the direction of the movement and not to obstruct the displacement of the latch, while in the other angular position the free end of this retaining lever interferes with the movement of the latch, preventing its retraction and thus complying with its retaining mission.

The two angular limit positions of the retaining lever are achieved by the action of a magnetic field existing between one magnet coupled to the retaining lever and another that is inserted in the self-locking rocker arm.

This self-locking rocker arm rotates around a horizontal shaft of the casing, being assisted by a recovery spring. The magnet is housed in the upper part and therefore at a certain radial distance, being mounted with the same polarity as the magnet of the retaining lever.

In the open door position, the latch and the rocker arm emerge from the front of the door. When the door proceeds to be closed, the strike first acts on the latch and then immediately afterwards on the rocker arm. The strike only has a housing for the latch, and therefore, in the closed door position, the rocker arm remains rotated towards the interior of the lock, with its magnet facing that of the retaining lever causing a repulsive field, due to which the retaining lever becomes embedded in the housing provided in the latch for producing self-locking thereof.

So, starting from these advantageous features of the patent of the main invention, compared to the state of the prior art, the present invention contributes certain improvements in various structural elements, improving the functionality of the mechanism with a simple operation and modular configurations, with which an economy of elements and low consumption is achieved, which entails irrefutable advantages.

### DESCRIPTION OF THE INVENTION

The present invention relates to a modular folding/sliding latch system with self-locking and multi-functional operation, for any type of access-control lock, from simple door retainers to mechanical, electrical and/or panic locks. The inventive system offers substantial advantages, namely: modular design, simple assembly, reduced size and easy installation. The structure of the modular folding/sliding latch system comprises a lateral frame or casing, a tilting latch and a sliding shoe guided between the lateral walls of said frame. The transverse shafts of the tilting latch and sliding shoe move in respective grooves, i.e., a longitudinal groove for the shoe, and a curved groove used to retract the latch when the system is being closed, and to retract same when the angle of rotation of the upper shaft is varied when the system is being opened, prior to releasing the lock. The latch may be crenellated and a there is a strike comprising an anti-lever recess.

In the present specification the term folding/sliding latch and tilting latch are completely equivalent.

The present invention refers more specifically to a modular folding/sliding latch system with self-locking and multifunctional operation for access-control lock, comprising:
a sliding shoe on parallel guides of a casing, from which
a folding/sliding latch emerges, oscillating around an axial shaft and being assisted by a hinge spring; and
a self-locking rocker arm, the sliding shoe being assisted by a sliding shoe recovering spring and linked to a retaining lever for the locking and release of the latch,

wherein the tilting latch possesses in its plane of incidence to the closure, a curvo-convex geometry and a radial connection of small curvature geometry in which a strike is adapted.

In general terms, according to the present invention, improvements are made to the folding/sliding latch system of the prior art. Among these improvements we can cite basically the following:

As in the case of patent application No. 200200790 cited above, there exists a casing inside which the modular folding/sliding latch system with self-locking and multi-functional operation is to be found, with four fundamental elements being involved for its functioning: a latch, a shoe, a retaining lever and a rocker arm. These four elements complemented by the operational form of retention that is selected from among those which conventionally exist, or specifically in the manner that we shall be discussing in relation to the figures, provide new features in the field of lock-making.

In the cited patent application the casing or box of the lock presents some parallel guides in its base with the aim of improving the alignment and sliding of the shoe to which the rocker arm is linked. The box is enclosed by a cover via its upper part and by a front plate which serves as a guide for the emergent elements, defined by the latch and the rocker arm. The rocker arm is the element via which self-locking is achieved for preventing retraction of the bolt once it is housed in the seat.

The latch is hollow, having a prismatic shape with its base in the form of a circular section and in its lower part and transversally it has a housing for coupling with the shoe, rotating in the manner of a hinge around a shaft, being furthermore assisted by a recovery spring. It has some tangential bevels in its sectorial lateral walls, which do not reach the point of cutting the vertices of the upper part, in order for this end to thereby act as a stop for delimiting the emergence of the latch. Laterally it has some housings, one on each side, in one of which will act the retaining lever so that it can perform its function. The fact that there exist housings on both sides is so that either one can be used depending on the construction of the lock in which the said retaining lever is to be fitted.

For its part, the sliding shoe has some corresponding parallel grooves for its correct sliding in the base of the casing, and in its upper part it has a space for housing the folding of the latch that rotates in it. Its rear part includes a projection with a hole for the passage of the guide shaft on which is mounted the compression spring that maintains the shoe and therefore the latch in the emergent position with respect to the front, in the rest state.

The retaining lever is an element that oscillates around an end shaft perpendicular to the base of the casing and which is fixed to the shoe, in such a way that in one rest position it remains supported against an emergent stop of the shoe in order for it to adopt a position longitudinal to the direction of the movement and not to obstruct the displacement of the latch. In the other angular position the free end of this retaining lever interferes with the movement of the latch, preventing its retraction and thus complying with its retaining mission.

The two angular limit positions of the retaining lever are achieved in this cited Invention Patent by the action of a magnetic field existing between the magnet coupled to the retaining lever and the one inserted in the self-locking rocker arm.

The self-locking rocker arm rotates around a horizontal shaft of the shoe, being assisted by a recovery spring. The magnet is housed in the upper part and therefore at a certain radial distance, being mounted with the same polarity as the magnet of the retaining lever.

In the open door position, the latch and the rocker arm emerge from the front of the door. When the door proceeds to be closed, the strike first acts on the latch and then immediately afterwards on the rocker arm. The strike only has a housing for the latch, and therefore, in the closed door position it remains rotated towards the interior of the lock and in this position its magnet is left facing that of the retaining lever causing a repulsive field, which has the consequence that the retaining lever becomes embedded in the housing provided in the latch for producing self-locking of the latch in order to prevent its retraction in any illicit action, as was expected to be achieved.

According to the present invention, the latch undergoes a change—with respect to the Spanish patent application mentioned above—in its external geometry though it maintains the same conception and use. The closing element is modified in order to prevent it becoming blocked in the possible grooves existing in the vertical structures of the profiles, which are basically metallic, on which the latch slides in its friction travel, both on entry when closing the door, and in opening it.

Another modification that improves the functionality is performed on the connection between the latch and the shoe, which is executed in such a way that its external part, in the rest or folded position, does not, on account of its coupling, permit the entrance of any foreign body, thus acting as a dust-guard.

In a general way in all applications, an assembly is made half-wall between the front plate and the cover and base of the closure.

In view of its behaviour in the prototypes that were made, the magnetic self-locking rocker arm incorporates a second magnet which perceptibly improves the philosophy of functioning considered in the main invention patent.

With this new configuration, the self-locking lever is held with greater firmness and it switches with less angular movement, the gap between the front plates of the lock and the strike is reduced, and a greater force of magnetic field is provided on closing the self-locking lever, with which a more efficient self-locking is produced.

In one of the preferred applications of this folding/sliding latch system that we are concerned with, as is its assembly in a electromagnetic panic lock, when it comes to testing on a test bench the behaviour of the prototype that was produced, it has been observed that the lock was subjected to great pressure stresses, above 5000 N, and it was necessary to strengthen the rigidity of the lock structure with some transverse columns or barriers. Their location forms a “barrier” between the self-locking lever and self-locking rocker arm, with the problem of its existence being solved by making a transverse hole in the nearest column, which permits movement of a separator which, via the smaller diameter end, has a magnet embedded which accompanies the self-locking lever (ferrite steel) in its displacement and at the other end it has a second magnet which, depending on the position of the new rocker arm and of the lever, precisely and with rapid switching combines the new locking and unlocking function of the anti-manipulation system.

For the majority of applications a new element is added needed for achieving the adjustment and solidity implied by locking on a convex surface: the moving strike. This is defined by a compact body essentially made up of two parts: the front plate with a seat for assembling with the rigidity shown by the saw-teeth arranged in its forward and rear face, and securing via the screws, which traverse the front plate being displaced according to the necessary adjustment in the transverse grooves of the strike, to some positioning nuts housed in the rear part thereof.

In accordance with the present invention, some improvements have also been introduced in the development of the electromagnetic-panic lock for eliminating the residual magnetism remaining between the sliding shoe and the core, and also for optimising friction between these elements in their displacement, and associating the sliding shoe in its travel with the inclined plane of the shoe, as we will see further below in relation to the figures. Independently of the pure iron forming the sliding shoe and the core of this assembly, inserted into the core is a steel ball under the pressure of a powerful spring which does not display any greater consumption when it comes to receiving voltage for overcoming the small gap during its travel, this pressure on the other hand being sufficient for overcoming the magnetism which might exist on a residual basis when the voltage is cut off. Ensuring de-locking between the sliding shoe and the core is basic in this application.

A second machining at the end of the sliding shoe houses an assembly—cover, gentle spring and separator—has the function in the central working position of the lock of keeping the core separate from the sliding shoe when there is no voltage in order to prevent displacements and friction between the two.

A simple magnetic switch within the core, in its upper part, ensures real monitoring of whether the lock is magnetised or not, this being an important simple signal for knowing when the exit is locked or passable.

A third recovery spring between the sliding shoe and a fastening in the casing reliably ensures displacement of the sliding shoe in harmony with the inclined plane of the shoe.

The necessary complement in emergency exits, generally with electromagnetic suction pads, is presence control, either electronic (volumetric element) or electromechanical (panic bars with monitoring). This complement is essential for remotely executing the exit control in times of from one second to 30 seconds, according to timing regulations. In order to optimise and include this complement into an electromagnetic panic lock like the one we are considering, a casing has been developed associated with the plate of the strike, where a simple mechanism is housed made up of a lever which, when displaced by a panic handle or square-sectioned panic bar, switches both a magnetic switch included in the lock and also a micro-switch included in the strike itself, providing an unequivocal double signal of presence.

Finally, another improvement introduced in the folding/sliding latch system forming the object of the invention is the key function with three differentiated positions, two for locking and the other being a push-return position for electromechanical opening. This last specific position has the aim of timed electrical opening of the lock with a key, under inhibition. In the upper locking, the sliding lever permits operation of the panic lock. In its displacement via the bulb, rotating the key in the anti-clockwise direction, the sliding lever is switches the lower micro-switch, enabling electrical opening if there is no inhibition. In the lower locking, when the pawl of the bulb is rotated in the clockwise direction, the sliding lever mechanically locks the opening system, and also, via the external management electronics, it cuts off the power supply to the locking unit.

In an improvement of the invention, the folding/sliding latch system displays the feature that the two basic elements—latch and shoe—have their shafts guided laterally on some frames or lateral walls of the casing for the lock, while previously they used to be guided in the base and in the front plate.

Also improved is the magnetic self-locking of the cited Patent, replacing it with another of the mechanical type, though its action is combined with electromagnetic means.

For this purpose, the lateral frames present two grooves: a longitudinal one for displacement of the shoe and the other in the form of a truncated arc which permits both concealment on closing and its retraction when varying the angle of rotation of the upper shaft when carrying out the opening, with prior release of the electromagnetic locking.

The shoe is retained in a parallel and linear manner by means of a lever which, under voltage, releases an electromagnet.

The latch of structure similar to that described with reference to the cited Invention Patent is concealable when closed and is crenellated in its lower part. It can display the folding/sliding variables via the inclined plane linkages for the better location of the locking elements, also being able to be double folding when the catch in the form of a circular cross-section has two of its vertices displaceable by including separate transverse shafts in them which are guided in pairs of curved grooves in the sides of the casing, as we will see later on in relation to the figures.

In the event of application of the invention to an electromagnetic panic lock, this consists of: the core pivoting on the frame, the sliding shoe and a “parrot beak” type tilting lever which pivots around a transverse shaft. The system self-locks when an ejector or bridge of is introduced in the groove existing for that purpose in said tilting lever, rotating it and with the existence of a recovery spring. Some micro-switches act on the magnetic core, switching and signalling the real open or closed state of the mechanism.

In another application of the invention, and maintaining the same philosophy of defining a concealable closing and opening via the convex plane of its geometric shape, the latch system can be rotated in two curved grooves of the lateral walls of the casing or frame, permitting double folding and its linear transmission via linkages. The concept of stress retention rather than traction stresses is maintained with the energy and functional advantages that this represents. The incorporation of linkages permits the complementary operational elements to work in different planes: retaining levers, coil, sliding shoes, opening by means of key/handle, etc.

The crenellated machining of the latch and a suitable strike provide a system of locking by traction since it is complemented by a centralised lock.

The transmission of the opening movement, once the opening lockings that act on the retaining lever have been released, either by the remote action of a coil or the action exerted by manual pressure on a lever linked at the ends of two parallel shoes secured in an oscillating fashion to the base of the casing, determines a jointed parallelogram which presses on and linearly displaces the thrust lever of the retaining lever for its release.

The coil performs the remote opening of the mechanical bar in controlled emergency exits in the absence of voltage in the electromagnetic element between the sliding shoe and the coil, standing in for the function of the electrical door-openers located for that purpose in fire-doors.

In order to facilitate an understanding of the characteristics of this invention and forming an integral part of this specification, some sheets of plans are attached containing figures which, by way of illustration only and not limiting, the following has been represented:

### BRIEF DESCRIPTION OF THE DRAWINGS

FIG. 1. Is a partial view in plan of a lock casing, without cover, which incorporates general lateral locking and a modular folding/sliding latch system with self-locking and multi-functional operation of the patent application cited in the section on Prior Art of the Invention.

FIG. 2a. Is a partial view from the front of the lock with the emergent elements: latch and anti-locking rocker arm.

FIG. 2b. Is a view from the line A-A of FIG. 2a.

FIG. 3. Is a view from B of FIG. 1, in the position in which the door is closed due to the lock facing the strike.

FIG. 4. Is a plan view of the lock assembly, similar to FIG. 1 but with is the door closed,'with self-locking being carried out.

FIG. 5. Is a section along the line of cut C-C of FIG. 1, once the lateral blocking has been released and the opening of the door has been performed under gentle pressure, without involving any handle.

FIG. 6. Is a side view, on a greater scale, of the shape and elements of the self-locking rocker arm, which emerges from the front of the lock.

FIG. 7. Is a plan view of a lock assembly, similar to that shown in FIG. 1, according to a variant of embodiment in which the sliding shoe includes a lateral wedge or wing for achieving sliding locking when it is acted upon by an sliding shoe also in a wedge and retained by the magnetic core.

FIG. 8. Is a perspective view of the electromagnetic assembly of sliding shoe and core, with voltage and without voltage respectively in positions a) and b).

FIGS. 9 and 10. Are respective views similar to FIG. 7, including the electromagnetic panic lock function, in the closed door position since its magnetic block is under voltage, permitting retraction of the shoe/latch block due to the fact that there is no voltage in the magnetic block.

FIG. 11. Is a partial view in plan of a lock casing in the open position, without cover, according to an improvement of the invention.

FIG. 12a. Is a plan view of the lock of FIG. 11 in the open door position and therefore separate from the strike, with the emergent elements being seen: latch and self-locking rocker arm. It also corresponds to a view along D-D of FIG. 12b.

FIG. 12b. Is a partial view from the side of the same lock of FIG. 12a, with the latch folded towards the interior of the lock in order to show the dust-guard protection of the hinge.

FIG. 13. Is a view from E of FIG. 11, in the position in which the door is closed due to the lock facing the strike.

FIG. 14. Is a diagrammatic side view in order to see the shape and elements of the self-locking rocker arm, which emerges from the front of the lock.

FIG. 15. Is a section along the line of cut F-F of FIG. 11, once the lateral blocking has been released and the opening of the door has been performed under gentle pressure, without involving any handle.

FIG. 16. Is a view of the front plate of the strike and displaceable strike prior to assembly.

FIG. 17a. Is a plan view of an electromagnetic panic lock as an application of the invention, in which the shoe includes, as considered in the main invention patent, a lateral wedge for achieving sliding locking when it is acted upon by an sliding shoe, also in a wedge, without voltage, with self-locking and night operation.

FIG. 17b. Is a section along line G-G of FIG. 7a.

FIG. 18. Is a plan view which schematically represents the arrangement of the elements necessary for forming a lock with low consumption motor operation for access control.

FIG. 19. Is a plan view of the electromechanical lock with coil, in which the few elements comprising it mean that it has sufficient space for containing the electronics needed for its control, and even in a standardised size that permits said access controls to be included.

FIG. 20. Is a plan view of a lock that defines another application of the invention, in this case panic bar with remote opening, which is governed by a low consumption geared motor.

FIG. 21. Is a view in side elevation of a general folding/sliding latch lock with self-locking and linear retention, according to another mode of embodiment of the invention.

FIG. 22. Is a view similar to FIG. 21, with the electromotive operation inverted due to the inclusion of some linkages.

FIG. 23a. Is a schematic view in side elevation of a crenellated folding/sliding latch in the locking position.

FIG. 23b. Is a view similar to FIG. 23a, but in the emerging position.

FIG. 23c. Is a section along the line of cut H-H of FIG. 23b .

FIG. 24. Is a side view of the strike of FIGS. 23a and 23b.

FIG. 25. Is a schematic view in side elevation of a conventional door leaf which includes the system for introducing the embedding elements.

FIG. 26. Schematically shows in three positions the respective phases of functioning of a “parrot beak” electromagnetic panic lock for various applications.

FIG. 27. Also shows in three positions the respective phases of the operational sequence for a panic bar including the electromechanical elements for remote opening, presence detection and electromagnetic retention. The positions b) and c) partially show the panic bar.

FIG. 28. Shows in two positions a) and b) the end of the sliding shoe, finished in the form of a prism, for acting on the retaining levers linked to the door bolt.

### LIST OF REFERENCES USED IN THE FIGURES

In the list below several numbers in the same entry denote the same element.

| Number | Element |
|---|---|
| 1 | casing |
| 2 | base |
| 3 | guides |
| 4, 4′, 62, 65 | sliding shoe |
| 5, 5′, 5″ | tilting latch |
| 6 | shaft |
| 7 | positioning spring |
| 8 | guide shaft |
| 9 | central projection |
| 10 | hinge spring |
| 11 | front plate of the lock |
| 12, 80 | rocker arm |
| 13 | tangential bevels |
| 14 | positioning projections |
| 15 | housing |
| 16, 61, 61′, 95 | retaining lever |
| 17 | end shaft |
| 18 | magnet |
| 19 | magnet |
| 19a | magnet |
| 20 | stop |
| 21 | front plate of the strike |
| 22, 22′ | lateral locking |
| 23 | magnetic locking |
| 24 | magnetic locking |
| 25 | shaft |
| 26, | micro-switch |
| 27 | bulb |
| 28 | seat |
| 29 | torsion spring |
| 30, 68 | strike |
| 31 | transverse columns |
| 32 | transverse opening |
| 33 | separator |
| 34 | spring |
| 35 | core |
| 36 | separator pin |
| 37 | spring |
| 38 | spring |
| 39 | steel ball |
| 40, 40′, 40″, 40′″ | retaining lever |
| 41 | second micro-switch |
| 42 | third micro-switch |
| 43, 43′, 43″, 43′″ | panic lever |
| 44 | magnet |
| 45 | magnetic switch |
| 46 | fourth micro-switch |
| 47 | motor |
| 48 | screw |
| 49 | steel wire |
| 50 | coil |
| 51 | low consumption geared motor |
| 52 | thruster |
| 53 | coupling element |
| 54 | spring |
| 55 | radial arm |
| 56, | transverse shaft |
| 57 | shaft |
| 58, 77 | groove of shaft 56 |
| 59, 78 | groove of shaft 57 |
| 60 | lateral frame |
| 63 | electromagnet |
| 64 | linkage pairs |
| 66 | crenellation |
| 67 | housing recess |
| 68 | strike |
| 69 | crenellated recess |
| 70 | central lock |
| 71 | hinges of the door |
| 72 | Tilting lever |
| 73 | shaft |
| 74 | opening |
| 75 | ejector |
| 76 | spring |
| 79 | linkages |
| 80′ | lever |
| 81 | retaining stop |
| 82 | lever |
| 83 | shoes |
| 84 | base |
| 85 | thrust lever |
| 86 | inclined plane |
| 87 | rear shaft |
| 88 | extension |
| 89 | follower |
| 90 | permanent magnet |
| 92 | core |
| 94 | prism |
| 96 | bolts |
| 97 | pivots |

### DESCRIPTION OF THE PREFERRED EMBODIMENTS

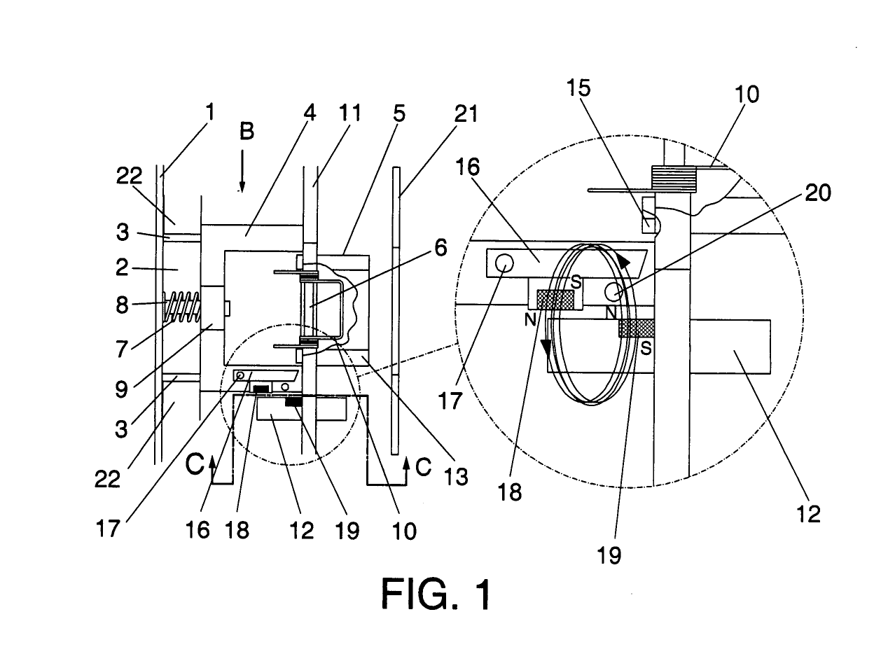

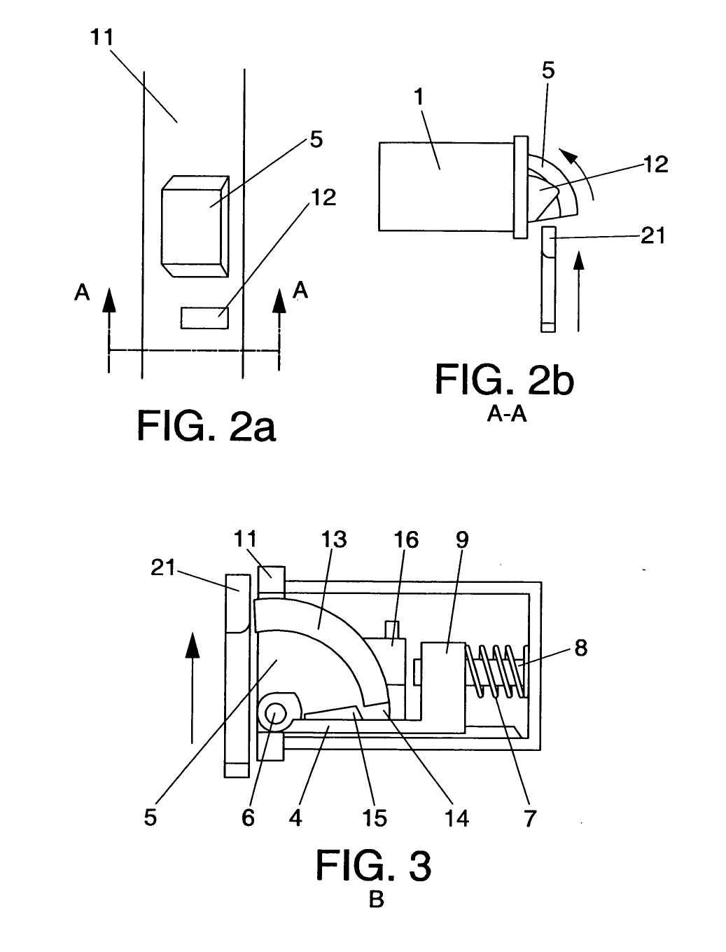

Making reference to the numbering adopted in the figures, in FIGS. 1 to 10, a modular folding/sliding latch system is shown, with magnetic self-locking and multi-functional operation, according to the cited patent application number 200200790.

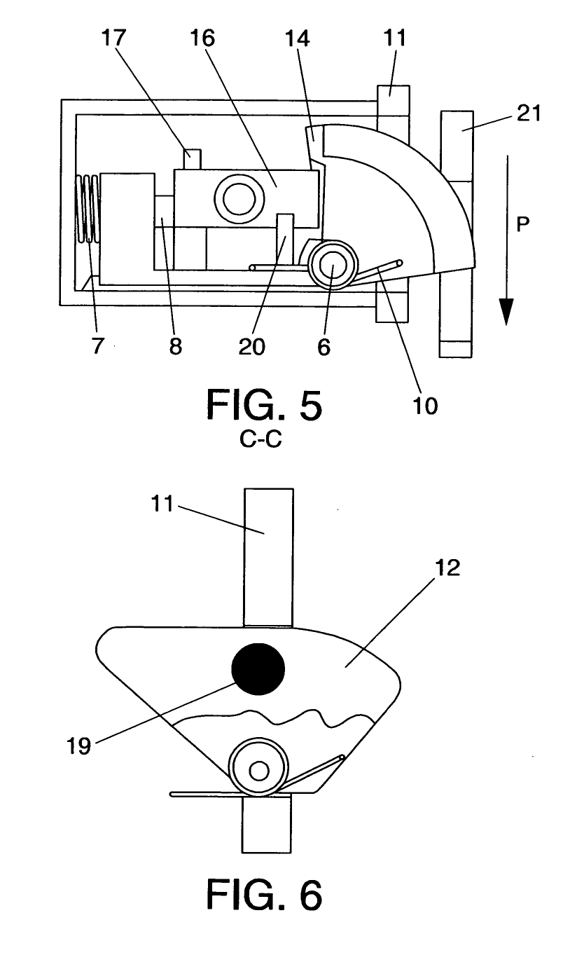

It is housed inside the casing 1 partially shown in FIG. 1 and which includes in its base 2 some parallel guides 3 with which the alignment of the sliding shoe 4 to which the latch 5 is linked is improved, the latter tilting around to the horizontal shaft 6 (see FIG. 3), the sliding shoe 4 being assisted by the positioning spring 7 provided around the longitudinal guide shaft 8 in the direction of movement and which passes through the hole provided in the central projection 9 emerging from the sliding shoe 4. The tilting latch 5 is also assisted by a double hinge spring 10 (see also FIG. 5).

The box or casing 1 for the lock is enclosed by a cover not represented in the figures, via its upper part, and by a front plate 11 of the lock provided with a pair of windows through which emerge and are guided the tilting latch 5 and the self-locking rocker arm referenced with number 12 the geometry of which is more clearly seen in FIG. 6.

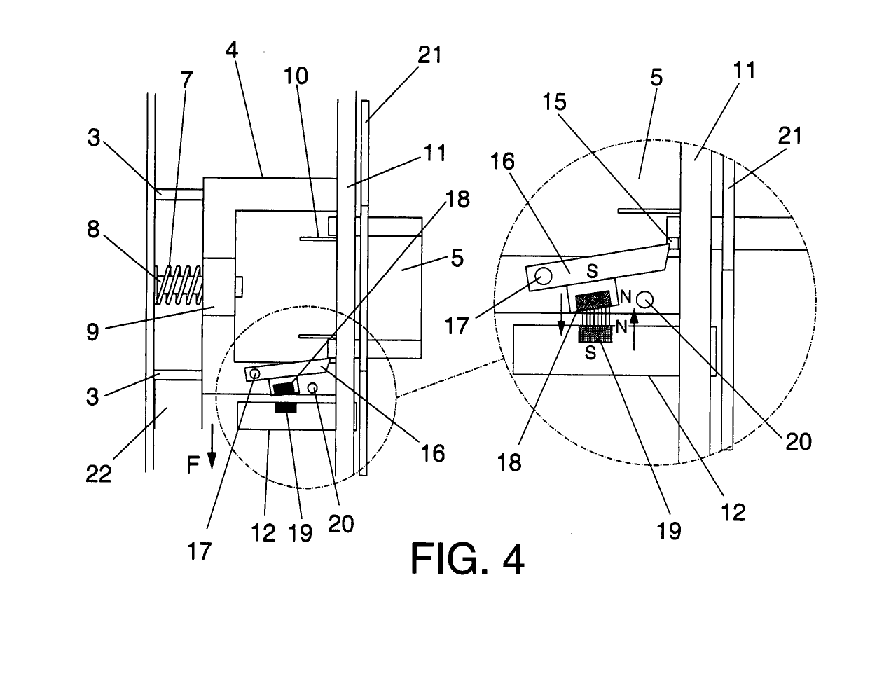

The geometric shape of the tilting latch 5 is deduced from observing FIGS. 3 and 4, being provided with some tangential bevels 13 with curved edges, without reaching the upper vertex, thereby defining certain positioning projections 14 thereof by impinging against the front plate 11 of the lock, thus delimiting its emergence.

FIG. 4 shows more clearly the existence of the housings 15 for the latch 5 in its sides, for the retention of the retaining lever 16 which oscillates around the end shaft 17 sunk into the shoe 4. The retaining lever 16 is integral with the magnet 18 provided so that the said lever can change position depending on the position occupied by another magnet 19 housed in the self-locking rocker arm 12 provided precisely in order to achieve that change of position of the retaining lever 16, which goes from the position shown in this FIG. 4 in which it performs its action of retaining or locking the latch 5, to that considered in FIG. 1 in which it occupies a longitudinal position of non-interference with that latch 5, in this case supported against the stop 20.

Analysing FIG. 1, we can see that when at rest with the door open, the linear separation existing between the magnets 18 and 19 generates an attractive field since the circular lines of forces try to become closed, which permits folding of the latch 5. On the contrary, in FIG. 4, which is shown in the is door closed position, as the rocker arm 12 is retracted, since the strike 30 only has the exit opening for the latch 5, this means that the two magnets 18 and 19 are facing each other, producing a repulsive field which deviates the retaining lever 16 to its position of locking the latch 5.

Referenced with number 22 in FIG. 1 are the means of locking the shoe 4 due to their becoming housed behind it. Even though these means are operative in this case, the door can still close without any effort since due to the polarity of the magnets 18 and 19 they try to approach each other given that they are not aligned, which permits folding of the latch 5 if it is acted upon.

In the elevation view of FIG. 5, the lateral locking 22 that retains the shoe 4 has been released and under gentle pressure (P) the opening of the door is performed without operating the handle.

The retentions of the operating locking 22 permit a range of configurations depending on the application of the system.

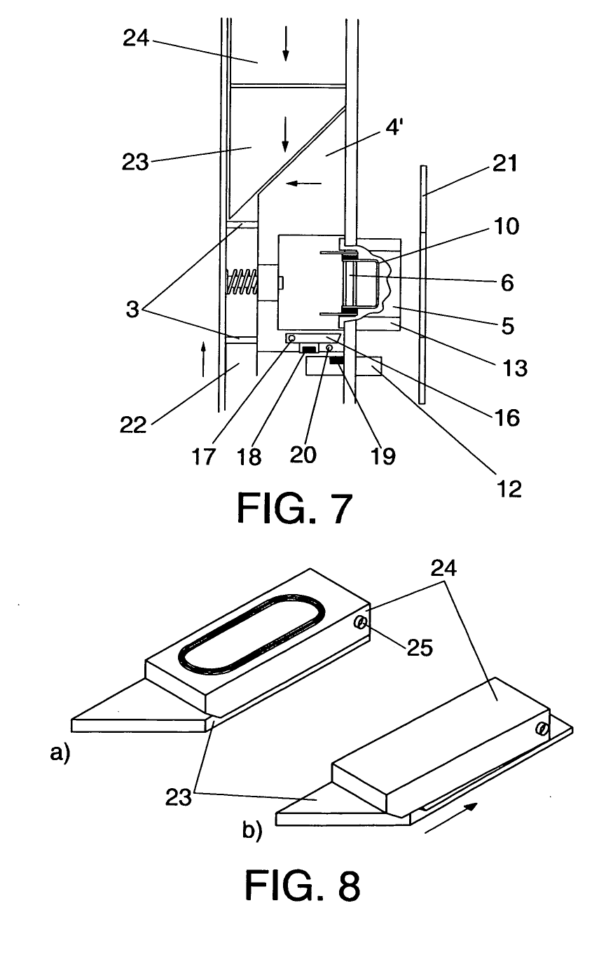

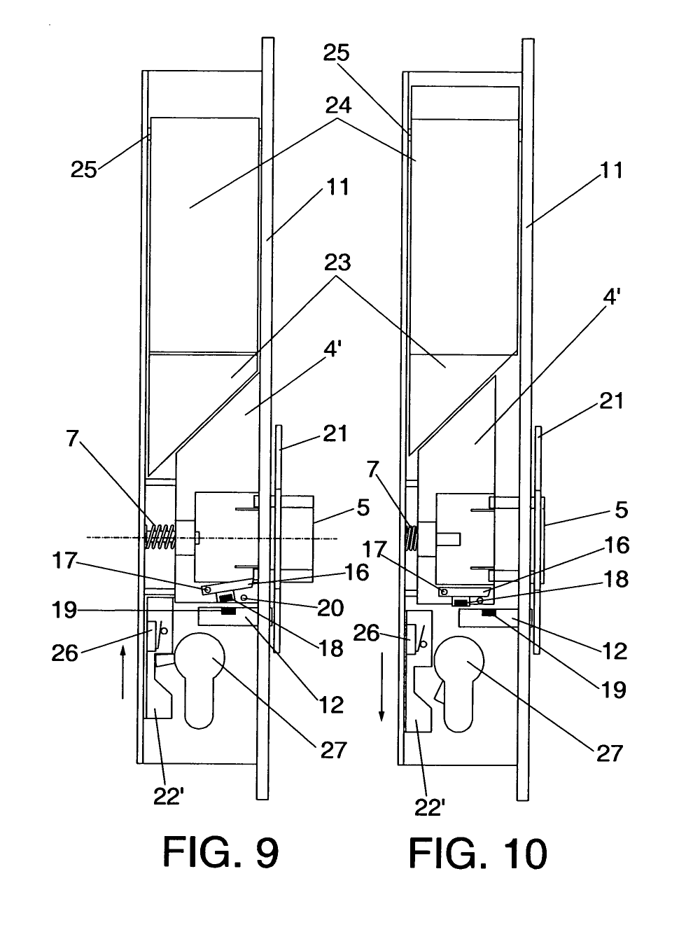

In FIG. 7, the shoe (4) is modified, since it has an extension in one of its sides (both sides can have this extension) in the form of an inclined plane, with its retention being carried out by means of the sliding stop or sliding shoe 23 (see FIG. 8), depending on the pressure generated by the magnetic field of the magnetic core 24 pivoting on its shaft 25, as is deduced from observing positions a) and b) of FIG. 8, respectively corresponding to the configuration of the door locked or at rest (door locked as shown in FIG. 9), and with the door opening as shown in FIG. 10, with this retention able to be double: two wings and two electromagnetic lockings 24-23.

The arrangement of the elements represented in these FIGS. 7 to 10 gives as a result the application of the system to a new function: the electromechanical panic lock.

The electrical panic lock is one that is normally open, in other words it locks under electrical voltage and which, in a situation of risk, has to permit the safe and effective evacuation through the door with a minimum effort and without any prior knowledge of the device, which is capable of opening in a situation of large “avalanche” pressures and without deformation once it has been transgressed.

In FIG. 9 the lock is in a closed door (the self-locking does not permit folding of the latch 5), it has voltage as does its magnetic locking 24-23 and a second optional operational locking is added which annuls the panic function of the sliding, consisting of a retainer 22′ incorporating a micro-switch 26 for signalling the locking position (night or burglar-proof operation), the action being governed by a bulb 27.

In FIG. 10 we can see the position with regard to FIG. 9, with the latch 5 projecting from its housing (the door being opened), without the lockings: magnetic, there is no voltage and the sliding shoe is displaced; and mechanical which does indeed permit retraction of the shoe/latch block.

According to what has been stated in relation to the structure in view of the figures, the present invention is based on a multi-functional development in which, at first sight, the arrangement of the closing and retention planes of the lock might cause surprise, since they are the reverse to the majority of arrangements. This entails a gentleness both on closing and on opening which, in terms of pressure, exceeds all existing regulations defining this field.

Secondly, a highly efficient self-locking is provided since, as well as eliminating the recovery springs and frictions of conventional systems, thus granting a limitless mechanical life, the utilisation of the magnetic fields permits functioning of the lock to be ensured with the minimum displacement (maximum tolerance between door and frame) and a very strong retention. Its configuration permits extremely fast assemblies, another factor of durability and economy. The small displacements that are necessary for its opening (except for the application of door retainer or passage door, which has none, not even self-locking) leads to minimum mechanical, electrical or electromagnetic displacements with extremely low consumption and reduced space.

The replacement on occasions of handles with bulkier ones permits greater convenience and design in the doors, both in mechanical systems and in access control.

The application to electrical panic locks of the example represented in the last figures to which we made reference (1 to 10) bear witness to the small volume needed for their implementation and their extremely low power consumption on account of the demultiplications achieved with the cascade to design of inclined planes.

In short, any application of the system in passage doors, filing cabinets, mechanical locks, panic bars, electrical locks, locks for access control, for panic, etc., entail irrefutable advantages.

It can also be pointed out that according to FIGS. 9 and 10, rotation of is the bulb 27 causes the retainer 22′ to be displaced for its locking or unlocking depending on the direction of rotation of its pawl, this function being registered in some complementary electronics by the switching of the micro-switch 26 for its processing and control.

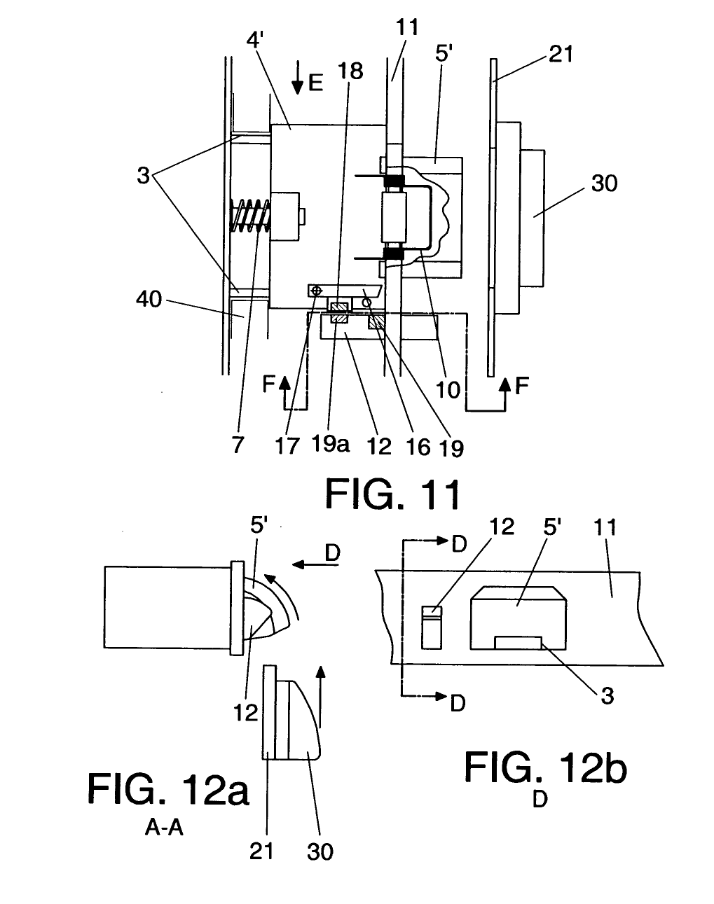

Making special reference now to FIGS. 11 to 20, one of the improvements which the invention proposes, and which defines a very broad spectrum of locks, includes the following basic characteristics in its essential elements:

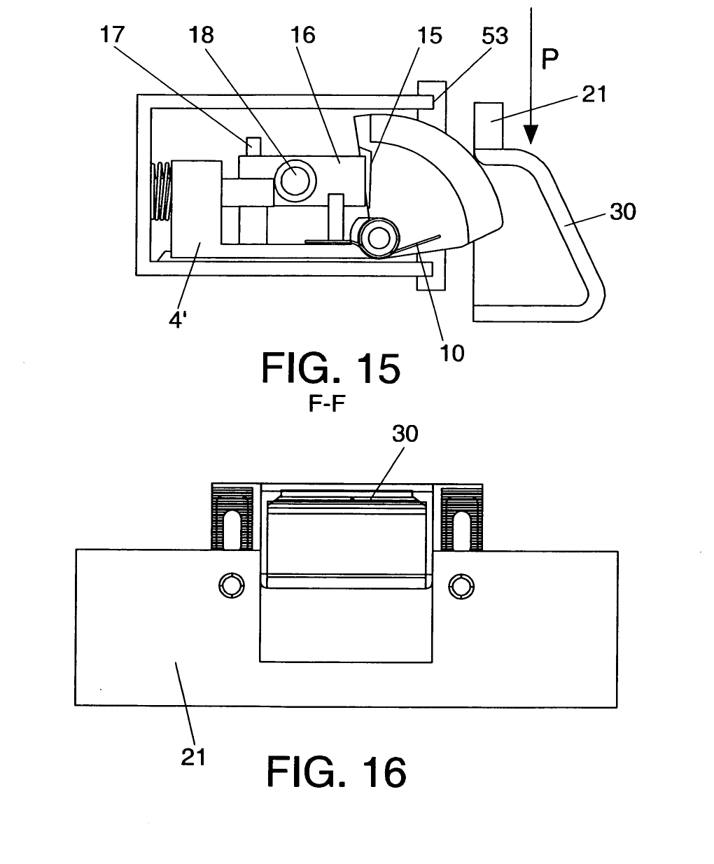

The actual tilting latch 5′ itself has convex geometry with tangential bevels, without reaching the upper vertex in order to thereby define the positioning projections thereof when impinging on the front plate 11 of the lock with its emergence being defined delimited by the upper face (see FIG. 12a). Later on, a slightly broken prism fits into the concave part with a slight radial link, and a seat 28 is provided in this plane for seamlessly coupling with the shoe and permitting the shaft of the hinge to be mounted for rotation thereof with respect to the sliding sliding shoe 4. Some housings 15 (see FIG. 15) are axially incorporated for the retention of the retaining lever 16. It is hollowed out internally for receiving the double spring of hinge 10 provided around the transverse guide shaft which couples with and passes through the sliding shoe 4′ (see FIGS. 11 and 15).

The sliding shoe 4′ possesses a transverse core which acts as a hinge for linking with the latch 5′, it has some side stops for delimiting the positioning thereof and a longitudinal core where the thruster shaft of the positioning spring 7 is guided. It also offers the perpendicular core 17 where the retaining or self-locking lever 16 rotates. According to the different configurations that can be offered depending on its application, it has a prismatic wing at 45° for being locked by the sliding shoe 23 (see figure where a panic lock is shown). Via the rear part, it bears two guides 3 for achieving the necessary parallelism in its displacement.

The retaining lever 16 rotates in the shaft 17 and bears the magnet 18 integral with it. Depending on the position of the magnets 19 and 19a of the rocker arm 12, of different polarity, it makes an angular movement for release or retention of the latch 5′.

The rocker arm 12 with rotation in the base and aided by the torsion spring 29 which is what positions it towards the strike has, as is considered in the cited Spanish patent application, a circular section geometry, in this case with two magnets of different strengths being inserted, referenced with the numbers 19 and 19a, one smaller (19a) of polarity opposite to the magnet 18 inserted in the retaining lever 16, and the other magnet 19 of greater strength, displaced from the first but at an equal distance, located in the more emergent part.

Given that the action of the strike 30 on the lock is produced first on the tilting latch 5′, while the small magnet 19a attracts the retaining lever 16, this permits folding of the tilting latch 5′. The retaining lever 16 immobilises the catch at the moment in which the tilting latch recovers its emergence due to the angular movement of the rocker arm 12 which causes its second magnet 19 of greater strength to face the magnet 18 of the retaining lever 16, these two magnets having the same polarity, which has the consequence that the retaining lever 16 is displaced through an angle so that its end is introduced in the axial housing 15 preventing its folding when it is acted upon illicitly.

Making special reference to FIG. 17, this shows a configuration of lock that incorporates an electromagnetic system for achieving a panic lock permitting pressures of 500 N and upwards, without any permanent deformation, as said earlier.

Reference 31 designates the transverse columns or barriers for reinforcing the rigidity of the structure of the lock. When interposing an interior barrier 31 between the retaining lever 16 and the rocker arm 12, a transverse opening 32 has been made in which the separator 33 moves which bears inserted in it a small magnet which makes contact with the retaining lever 16 and accompanies it in its movement. At the opposite end of greater diameter, it includes the magnet 18 which is the one that cooperates with magnets 19 and 19a of the rocker arm 12.

The electromagnetic system is improved both in displacements and in the elimination of residual magnetism and the signalling, incorporating a traction spring 34 between the sliding shoe 23 and the casing, improving the harmonic displacement between this sliding shoe 23 and the inclined plane of the sliding shoe 4′. The friction existing between the core 35 and the sliding shoe 23 at no voltage is made to disappear by introducing a separator pin 36 into the head of the core forced by a small spring 37, as shown in FIG. 17b. There is no collision between the inclined planes of the sliding shoe and the core.

In this same FIG. 17b which is a section through line G-G of FIG. 17a, in the middle part of the core a spring 38 can be seen, which exerts pressure on the steel ball 39. The small gap shown by the spherical cap does not prevent magnetic locking, and is sufficient for mechanically ensuring the demagnetisation that could be generated by the residual magnetism. This is an important added safety value in the panic application.

Also incorporated in the core is the magnetic switch 26. Its switching, if there exists a gap between the core and the sliding due to voltage break, by means of monitoring, indicates that the lock is unlocked and therefore the emergency exit is passable.

In this same model of panic lock of FIG. 17a, the optional application of a lever 40 with two positioning notches can be seen, one of said positioning notches is for displacing said lever 40 via the bulb 27, mechanically locking the closure element and switching the second micro-switch 41 which monitors this state and cuts off the power supply to the lock itself; this position corresponds to the one represented in FIG. 17a and which corresponds to the night operation with electrical disconnection (museums, entertainments halls, etc.), thereby avoiding risk of fire in risk zones during out-of-work hours. The second notch has an inclined plane which permits displacement towards a third micro-switch 42 adjacent to the previous one to be increased operatively, for electrical opening both from the outside and from the inside.

In this same panic lock application, in accordance with the invention another new contribution is made which is presence control integrated into the casing facing the front plate 21 of the strike. This simple mechanism consists of a panic lever 43 or square-sectioned panic bar which, in its angular travel, displaces a simple magnet 44 from the zone of magnetic influence that switches a magnetic switch 45 and in its middle part switches a fourth micro-switch 46. These two signals, duly processed and timed, provide an unequivocal double presence control in the emergency exits.

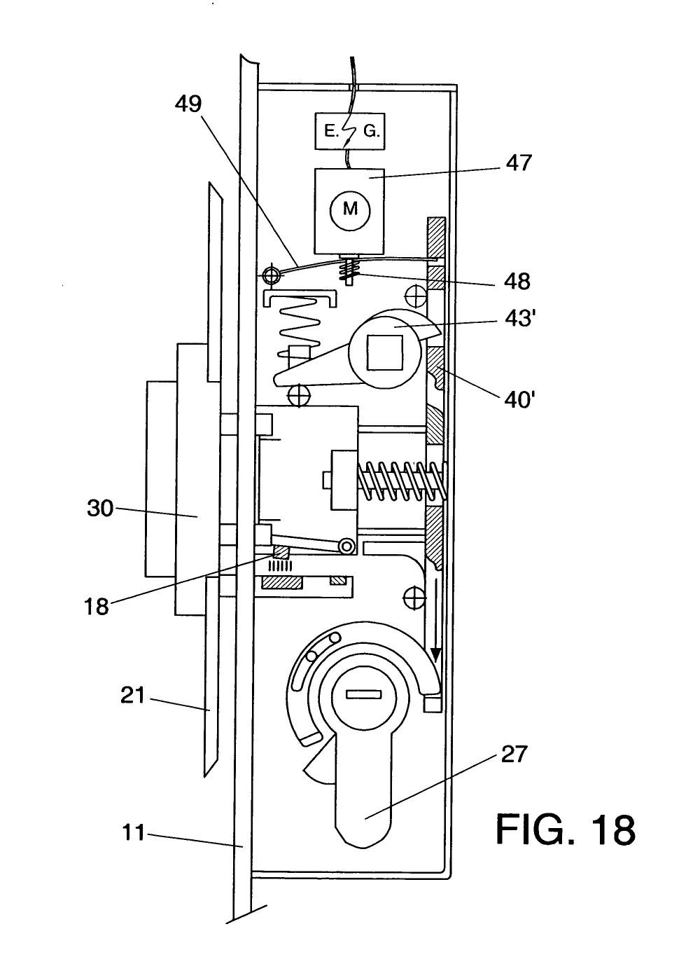

FIG. 18 is a diagram of a bi-stable lock for access control in narrow shapes, incorporating a small motor 47, such that from its shaft a screw 48 emerges. Said screw, depending on the direction of rotation, via a double steel wire 49 with rotation at one end, displaces the retaining lever 40′ at the other end when sliding on the threads of the screw, locking the closure, this being a position which corresponds to that shown in FIG. 18 that we are considering.

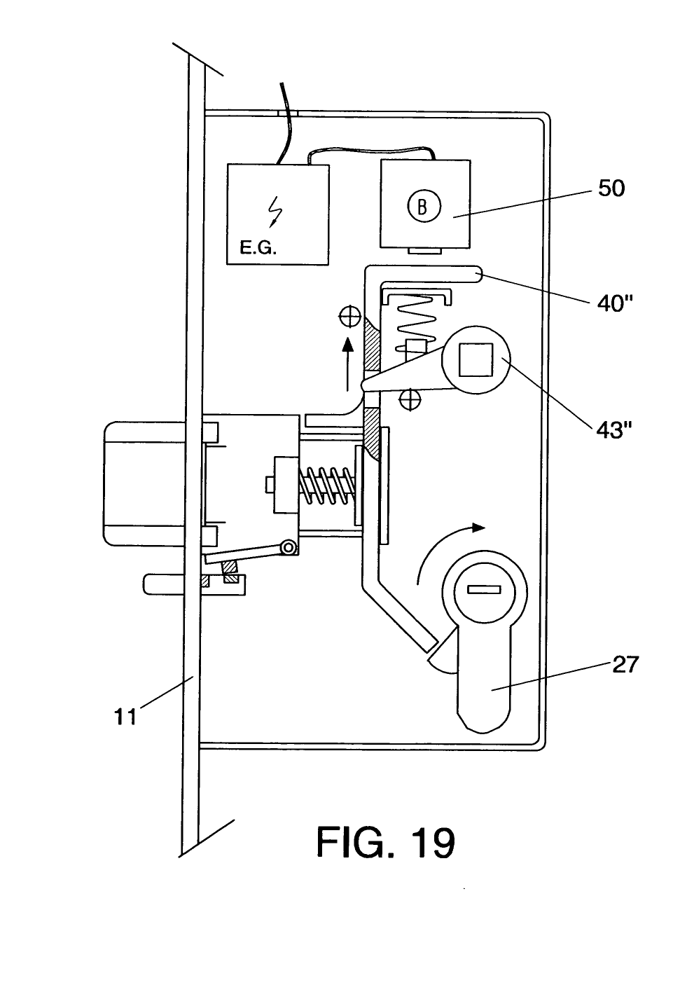

According to another of the embodiments of the invention, as is the case of the electromechanical lock with coil, represented in FIG. 19, it has a configuration similar to that of the bi-stable lock of the previous example. In this case, a coil 50 is used. The few locking elements permit the incorporation of management electronics for timing the electrical functions, among other applications. This is an application for cases in which there does not exist a power source with batteries, for example in front doors of buildings. It is differentiated from the bi-stable model in that, in the event of a power failure, the door stays locked, behaving like a conventional mechanical lock.

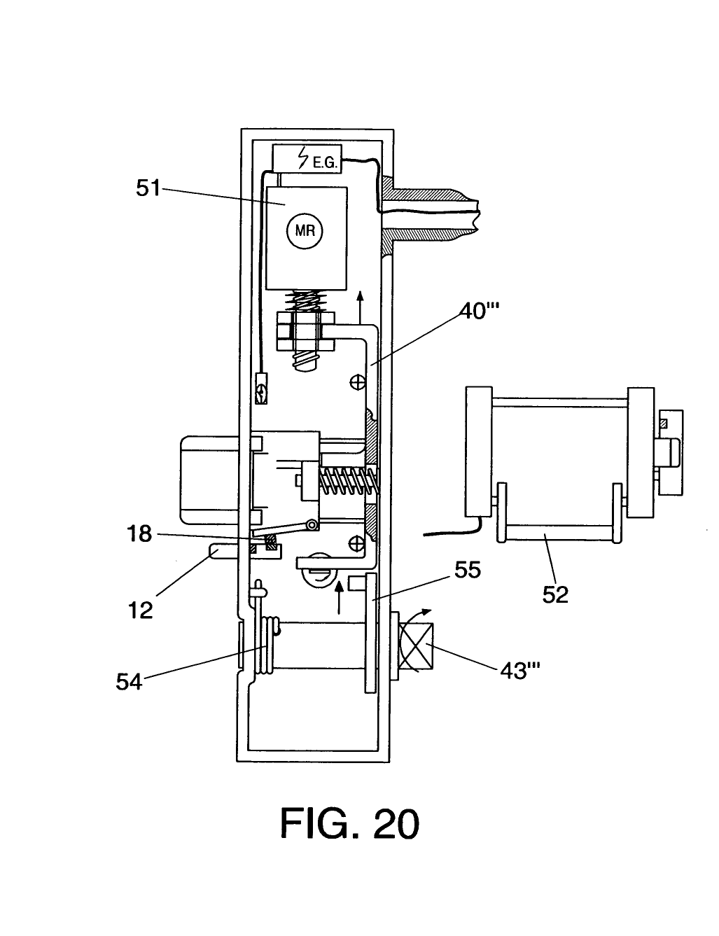

Referring now to FIG. 20, we can see another application, in this case a remote opening panic bar which is governed by a low consumption geared motor, referenced with number 51, with remote opening associated with management electronics incorporated for the control of effort and travel, which at all times permits manual opening by acting mechanically on the thruster 52.

As far as the locking system is concerned represented in the examples described above, we can state that, apart from in the case of the panic lock which is formed from the inclined plane of the sliding shoe 23 via the upper part and by means of the lever 40 via the lower part (see FIG. 17a) for night operation, in the rest it is formed from a lever 40′, 40″ or 40′″, guided wholly or coupled depending on the features corresponding respectively to FIGS. 18 to 20, which presents certain protuberances and cavities so that the operational elements, whether electrical or manual—handles or bulbs—can act on it.

In all the embodiments, the introduction of a conventional key cylinder, on operating levers is considered, both for its habitual use, emergency, or for special needs: night operation.

Apart from in the obvious case of the handle of the panic lock for electrical opening, whether immediate or controlled by a timer (open under inhibition), as with the key of the same model, all the others are mechanical, acting on the locking lever, with free exit. Given the characteristics of the folding/sliding latch system that is proposed, both the handle and the bulb can act electrically or under inhibition on electrical micro-switches depending on the management electronics associated with it.

As previously stated, the strike 30 with slight modifications in the applications of the panic bar (see FIG. 17a) displays a constructive form that protects and is adjusted on the convexity of the latch, making the locking is operation more solid.

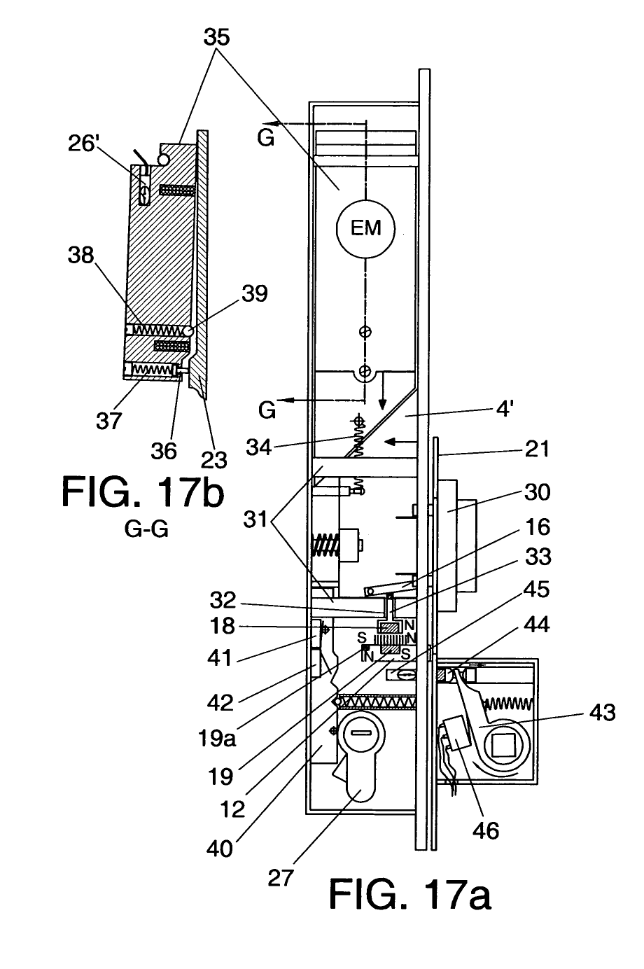

In relation to FIG. 16 where the front plate 21 of the displaceable lock strike 30 can be observed, it can be seen how the latter is left embedded in an adjustable manner in the front plate for being adapted to the convex geometry of the latch, therefore having a concave surface protecting the latter and strengthening the safety of the lock.

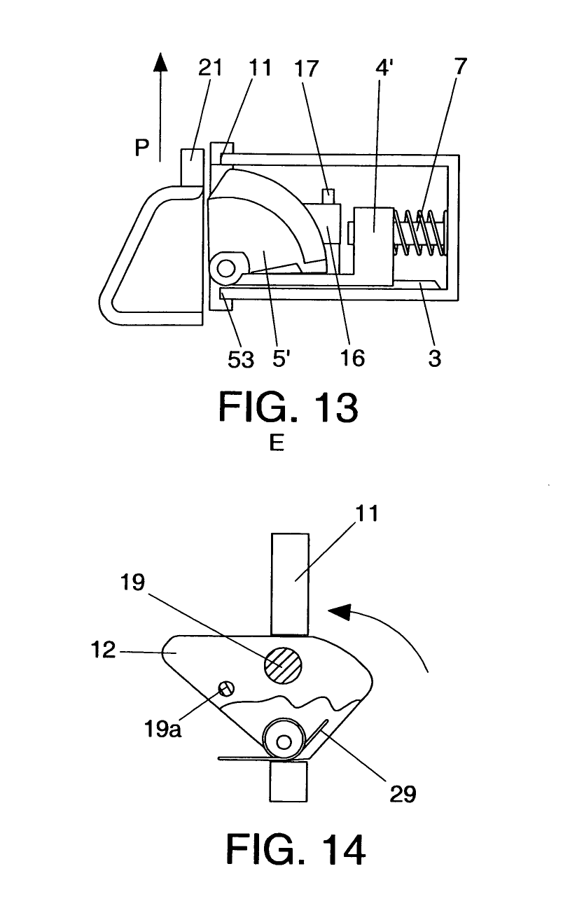

Constructively in all applications, both the base of the casing and the cover are embedded half-wall, being coupled at least in the zone of the latch 5′ in the front plate of the lock 11, as indicated the coupling element with reference 53 in FIGS. 13 and 15, with which the alignment and rigidity of the system is increased.

Given the differential characteristics contributed by the folding/sliding latch system, the manual openings described in the examples of application do not necessarily have to be mechanical but can instead, in the example that was discussed of the panic lock, be electrical: the handles and bulbs acting on micro-switches duly installed with or without inhibitions.

Making reference again to FIG. 20, the reference 54 designates a spring which assists the shaft of the lever 43′″ associated with a panic bar, including a radial arm 55 able to make contact with the retaining lever 40′″ in order to displace it in the direction of releasing the lock.

According to particular embodiments of the invention, it refers to a modular folding/sliding latch system with self-locking and multifunctional operation for access-control lock, comprising:
a sliding shoe (62) on parallel guides of a casing, from which
a folding/sliding latch (5″) emerges, oscillating around an axial shaft (56) and being assisted by a hinge spring (10); and
a self-locking rocker arm (12), the sliding shoe (62) being assisted by a positioning spring (7) and linked to a retaining lever (61) for the locking and release of the latch (5″),

wherein the tilting latch (5″) possesses in its plane of incidence to the closure, a curvo-convex geometry and a radial connection of small curvature geometry in which a strike (30) is adapted.

The core (35, 92) can incorporate a magnetic switch (26) which in the event of a power cut, is switched by monitorisation, indicating that the lock is unlocked and therefore its emergency exit is passable.

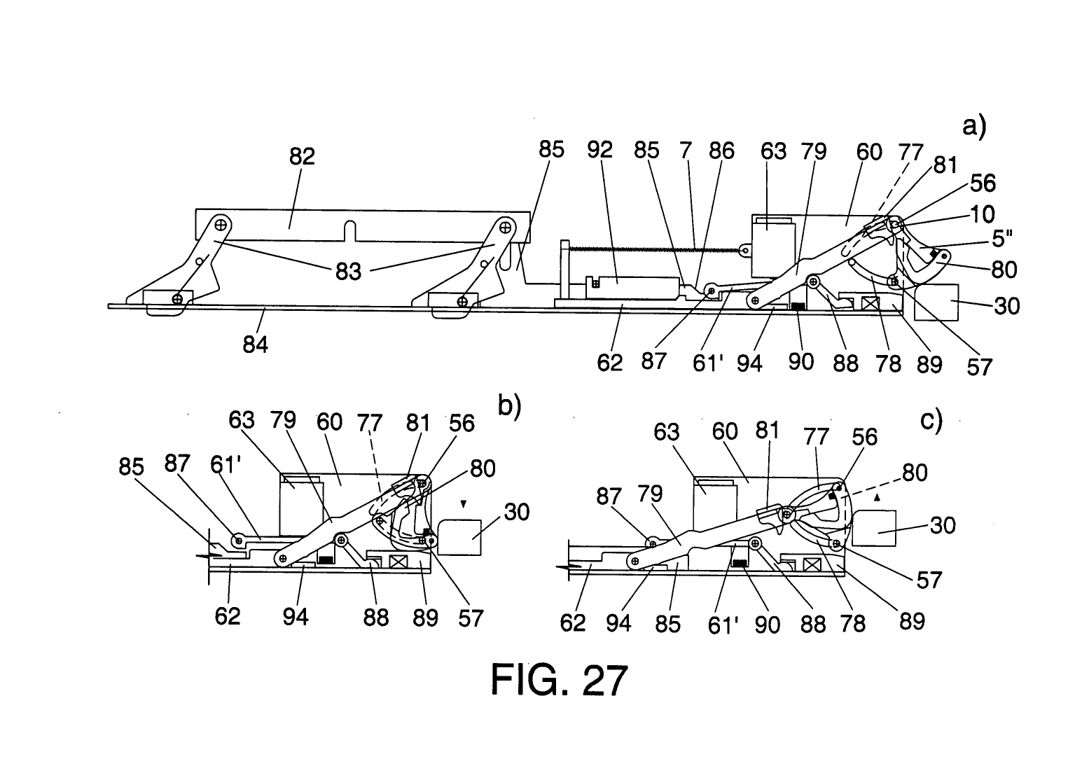

According to particular embodiments, such as the one shown in FIG. 27, the tilting latch (5″) and sliding shoe (62) have projecting transverse shafts (56, 57) guided in lateral frames (60) which are provided with two grooves (58), 59), one longitudinal (58) for displacement of the sliding shoe (62) and the other (59) in the form of a staggered arc permitting both concealment of the latch (5″) on closure, and its retraction when the angle of rotation of the linkage shaft with the shoe (62) is varied when opening is carried out, with prior release of the locking.

The sliding shoe (62) can be retained in a parallel and linear manner by a lever (61) oscillating at one end and which at the other incorporates a bent retaining ratchet, said sliding shoe (62) being released by means of an electromagnet (63) which attracts said retaining lever (61), there existing a permanent magnet (90) for recovery of its locking position.

The tilting latch (5″) can be concealable on closing the door—crenellated in its lower part is folded via ateral linkages (64) linked to the first transverse shaft (56) of the latch and to the second transverse shaft (57) of the sliding shoe (65) on which the oscillating retaining lever (61) acts.

In another embodiment the tilting latch (5″)—concealable on closing and crenellated in its lower part—is double folding with a catch for at all times permitting closure of the door via linkages (79) linked to the sliding shoe (62).

The latch (5″) can offer concealable closing and opening via the convex plane, due to the frame (60) including two curved grooves (77, 78) which permit double folding and its linear transmission via linkages (79); there existing the self-locking lever or rocker arm (80) which is displaced via the interior of the latch (5″) and is assisted by a recovery spring, and a second lever (80′) which links in the same rotating shaft of the self-locking rocker arm (80) and which directly receives the impact against the strike (30), in turn pushing with its pressure spring on said self-locking rocker arm (80), acting on a retaining stop (81) which joins the ends of both linkage pairs (79).

The folding/sliding latch system can have two parallel shoes (83) linked via one of their end pairs to a base (84) of the casing, and the other ends to a communal lever (82) forming a jointed parallelogram which presses on and linearly displaces a thrust lever (85) which carries an inclined plane (86) at its active end, raising up the rear shaft (87) of the retaining lever (61′) for its is release via said inclined plane (86) that said thrust lever (85) incorporates for the purpose. Said thrust lever (85) can switch a micro-switch which sends a signal for processing when the bar incorporates electromagnetic retention between the sliding shoe (62) and a core (92) in timed control exits.

The retaining lever (61′) can be actuated by the rotation of a follower (89) of the lock on a convexity of forming an extension (88) of said retaining lever (61′).

The sliding shoe (62) can be assisted by a spring (7) for recovering its original position, and can include a prismatic finish (94) which connects with retaining levers (95) linked to bolts (96) bearing latches (5″) or similar at their locking ends.

Furthermore the rocker arm (12) incorporates two magnets (19, 19a) of different strengths and polarity, which are able to confront each other alternating with a magnet (18) of the retaining lever (16), in the two positions of the latch (5″), allowing the introduction of barriers (31) collateral to the sliding shoe (4′).

Also, the modular folding/sliding latch system can include a lever (40) with two positioning notches, displaceable by a bulb (27), one mechanically locking the latch and switching a second micro-switch (41) which monitors this state and cuts off the power supply; while the other notch, via an inclined plane, permits the displacement towards the third micro-switch (42) to be incremented for electrical opening, both from the outside and from the inside.

The folding/sliding latch system can further include a presence control integrated into the casing backed onto a front plate (21′) of the strike (30) which consists of a lever (43, 43″) actuated by a panic handle or square-sectioned panic bar which, in its angular movement, displaces a magnet (44) from a zone of magnetic influence that switches a magnetic switch (45) and in its middle part switches a fourth micro-switch (46); these two signals, duly processed and timed, providing an unequivocal double presence control in emergency exits.

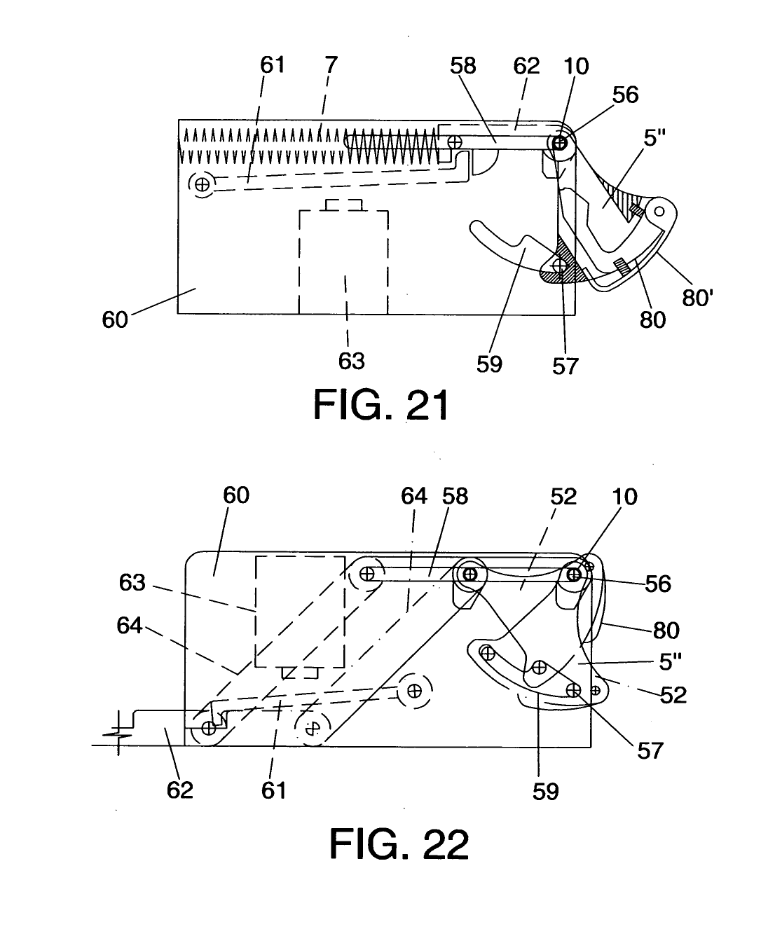

Making special reference to FIGS. 21 and 22, we can see how the modular folding/sliding latch system with self-locking and multi-functional to operation includes a series of improvements with a very simple embodiment as shown in FIG. 21. The tilting/sliding latch 5″ is traversed by the shafts 56 and 57 whose projecting ends fit into the respective grooves 58 and 59 made in the form of a pair in the two lateral frames 60, or lateral plates on which the sides of the prismatic latch 5″ make contact, thus having optimum guiding.

The magnetic self-locking of the cited Spanish patent application is changed into a mechanical locking materialised by the action of the oscillating retaining lever 61 which includes at its end a bent ratchet. Said bent rachet is intended for retention of the end, also bent, of the sliding shoe 62. The retaining action of the oscillating lever 61 is released by means of the electromagnet 63.

FIG. 22 shows a new arrangement of these same functional elements of the latch (5), changing the place of the locking elements, i.e., the oscillating lever 61 and the sliding shoe 62 due to providing linkage pairs 64. In this FIG. 22 another operating position can also be seen shown with dashed lines. In this case the oscillating retaining lever 61 is connected in a staggering of the sliding shoe 65 and permits the electromagnet 63 to be located in the opposite part.

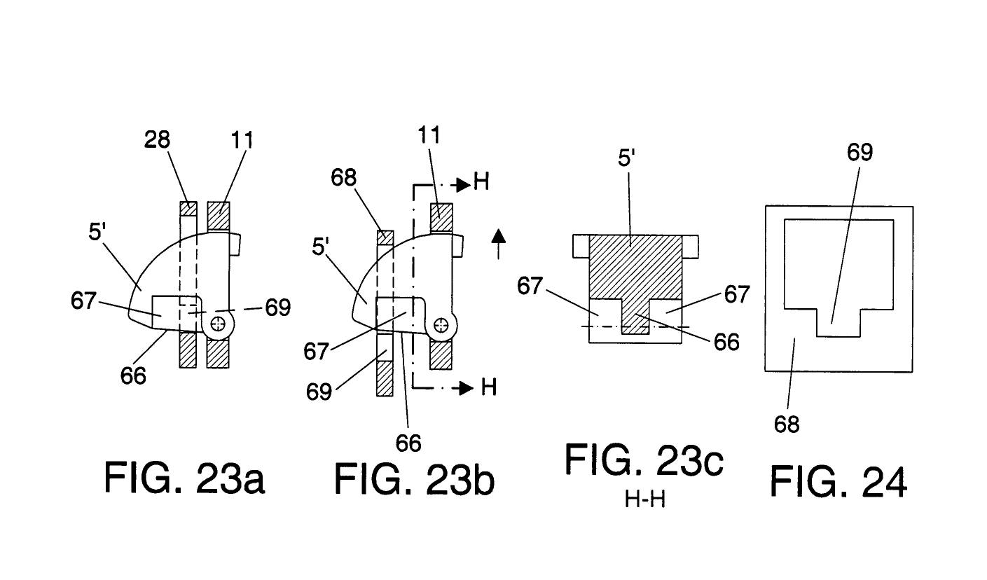

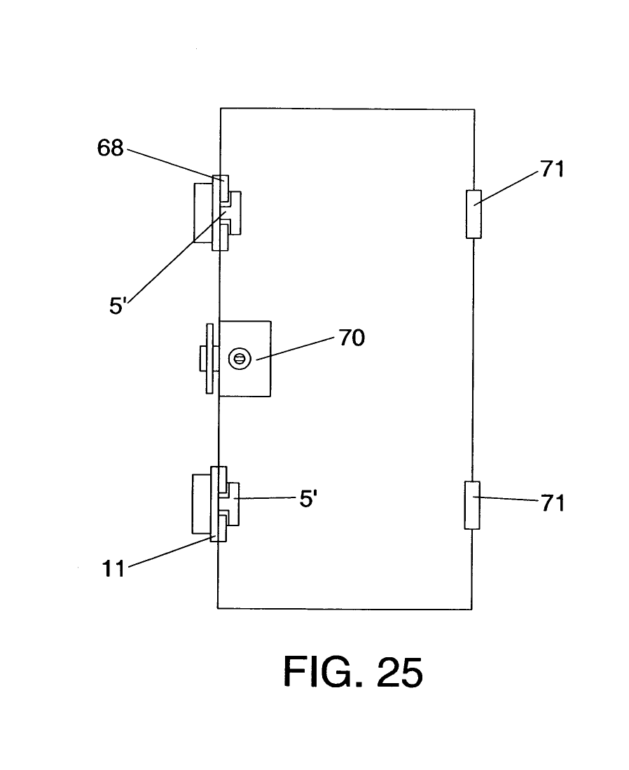

Making special reference to FIGS. 23 to 25, the tilting latch 5′ has a similar configuration to that of the cited Spanish patent application, being concealable on locking and presenting a crenellation in its lower part, referenced with number 66 and formed between two housing recesses 67 of the larger faces thereof. This geometry corresponds to that displayed by the strike 68 as can be clearly seen in FIG. 24. The wall of the crenellation 66 of the latch 5′ is able to be introduced into the crenellated recess 69, passing from the emergent position (FIG. 23b) to that of locking (FIG. 23a). The folding/sliding variables can be presented by linkages or inclined plane, in a way similar to that mentioned in relation to the FIGS. 21 and 22. It can also be double folding: the catch of FIG. 27 which will be referred to below.

The system permits closing and opening at all times unless it incorporates a conventional centralised lock, as is the case of the example shown in FIG. 5. Given the peculiarities of the crenellation and of the geometry of the strike 68, this system, with the aid of the central lock 70, prevents forcing by means of traction (crowbar) between the door and the frame. The reference 71 indicates the hinges of the door. The mounting elements are materialised by the latches 5′.

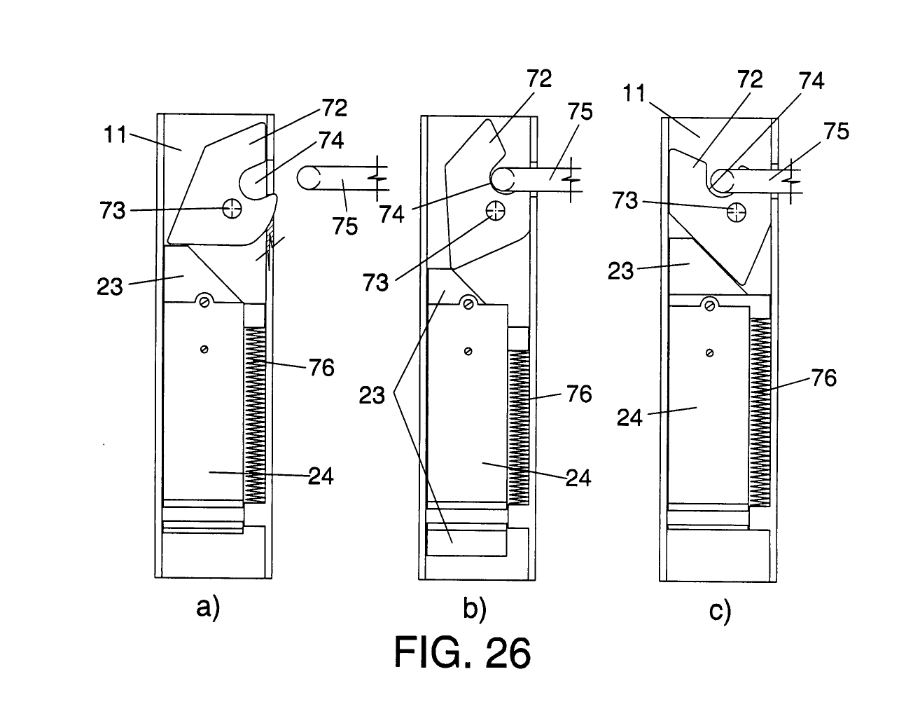

FIG. 26 shows an elementary electromagnetic panic lock according to another form of embodiment of the invention in which said lock consists of three basic elements: the magnetic core 24 pivoting on the front plate 11 of the lock, the sliding shoe 23 and the tilting lever 72 of the type known as “parrot beak” which pivots around the shaft 73. The ejector or bridge that is introduced into the opening 74 of the tilting lever 72 is referenced with the number 75. The is system self-locks by introducing the ejector 75 into the opening 74, by the action on the inclined planes thereof for demultiplication of efforts, as can be deduced from observing the different positions a), b) and c) of FIG. 26. The spring 76 provides support for resetting and retention, along with the micro-switches which act on the magnetic core 24 switching and signalling the real open or closed state of the mechanism.

In relation to FIG. 27 which also includes three sequential operational positions a), b) and c), we can see that the latch of this lock, as with the preceding applications, maintains the same philosophy as in the cited patent application: concealable closing and opening via the convex plane. In this case the differential aspect lies in the embodiment of the frame 60 of the two curved grooves 77 and 78 for permitting double folding. The linear transmission is effected via the linkages 79.

The self-locking or oscillating piece in the interior of the latch 5″ is the rocker arm referenced with the number 80 (this element 80 can also be seen in FIGS. 21 and 22), this being the component that first makes contact with the strike 30. Its recovery spring acts in a very simple manner as can be seen in the three sequences of this FIG. 27, on a retaining stop 81 which is coupled to the linkages 79.

In this FIG. 27 the recovery spring 10 for the emergence of the latch 5″ has not been represented—although the reference number has been introduced—with the aim of not overloading the drawings excessively, said spring being a double rolled torsion spring located between the retaining stop 81 and the latch itself 5″.

Returning to FIG. 21, in it can be seen an upgrading of the invention, defined by the existence of a second lever 80′ which is linked to the same rotation shaft of the rocker arm 80. The lever 80′ remains outside and is held to the latch 5″ via its inner zone.

On closing the door, the lever 80′ impinges first of all with the strike 30 and pushes the oscillating rocker arm 80. There exists a pressure spring inserted between these oscillating elements on the same shaft.

In FIG. 27 the second lever 80′ has not been represented in order not to overload this figure, though the latch 5″ does indeed include it.

For the opening movement, once the lockings exerted on the lever 61 have been released, this is obtained by remote action of the electromagnet 63, or that exerted by manual pressure on the lever 82 which in an oscillating manner joins the free ends of the shoes 83 which oscillate around fixed points of the base 84. A jointed parallelogram is thus formed for displacing the thrust lever 85 which carries an inclined plane 86 at its active end, raising up the rear shaft 87 of the retaining lever 61′. In this case that lever has been referenced with 61′ since it is endowed with an extension 88 with a swelling, which will be acted upon by the follower 89, thus carrying out the opening. The recovery of the retaining 61′ is achieved by the action of a permanent magnet 90.

The thrust lever 85 signals its operativity, a presence signal, by switching a duly installed micro-switch which has not been represented, sending the signal remotely when the panic bar incorporates the electromagnetic retention effected by the sliding shoe 62 and the magnetic core 92.

According to particular embodiments the sliding shoe comprises integral lateral inclined planes defining the electromagnetic retention between the sliding shoe 65 and the magnetic core 92

The sliding shoe 62 is provided with a staggering for being retained by the lever 61′.

The sliding shoe 62 associates a traction spring 7 (which can also be a compression spring) for recovering the original position, replacing the classical electromagnetic suction pads that are installed complementing the mechanical bars at the controlled emergency exits.

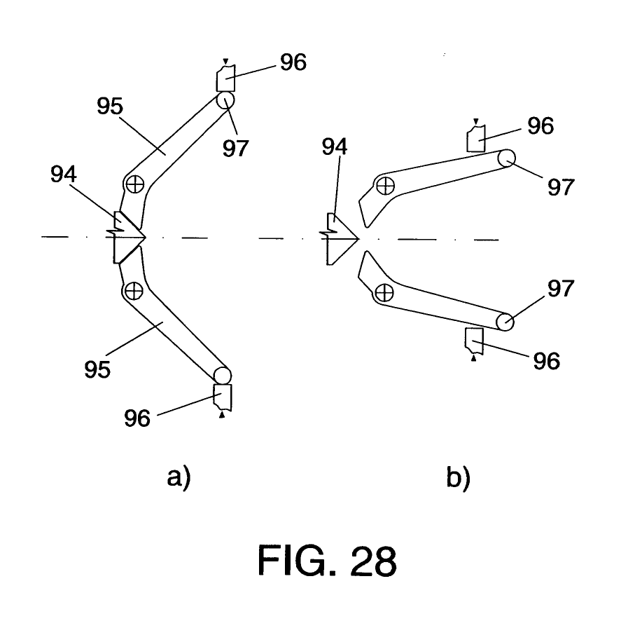

The sliding shoe 62, as well as the retention planes on which the core 92 and the lever 61′ act, includes in its forward part a finish in the form of a prism 94 which serves to contain the retaining levers 95 (as can be seen in FIG. 28, positions a) and b)) for releasing the bolts 96 in its delocking, these bolts having at the locking ends (upper-lower or lateral) some latches similar to the central latch of the bar, or similar to that represented in FIGS. 21 and 22. The retaining levers 95 include separate pivots 97 in their ends linked to the bolts 96.

1. Modular folding/sliding latch system with self-locking and multifunctional operation for access-control lock, comprising:
a sliding shoe (62) on parallel guides of a casing, from which
a folding/sliding latch (5″) emerges, oscillating around an axial shaft (56) and being assisted by a spring (10); and
a self-locking rocker arm (12), the sliding shoe (62) being assisted by a positioning spring (7) and linked to a retaining lever (61) for the locking and release of the latch (5″),
wherein the tilting latch (5″) possesses in its plane of incidence to the closure, a curvo-convex geometry and a radial connection of small curvature geometry in which a strike (30) is adapted.

2. Modular folding/sliding latch system with self-locking and multifunctional operation according to claim 1, wherein the sliding shoe comprises integral lateral inclined planes defining an electromagnetic retention between the sliding shoe (65) and a core (92).

3. Modular folding/sliding latch system with self-locking and multifunctional operation according to claim 2, wherein the core (92) incorporates a magnetic switch (26) which in the event of a power cut, is switched by monitorisation, indicating that the lock is unlocked and therefore its emergency exit is passable.

4. Modular folding/sliding latch system with self-locking and multifunctional operation, according to claim 1, wherein the tilting latch (5″) and sliding shoe (62) have projecting first transverse shaft (56) and second transverse shaft (57) guided in lateral frames (60) which are provided with two grooves (58, 59), one longitudinal (58) for displacement of the sliding shoe (62) and the other (59) in the form of a staggered arc permitting both concealment of the latch (5″) on closure, and its retraction when the angle of rotation of the linkage shaft with the shoe (62) is varied when opening is carried out, with prior release of the locking.

5. Modular folding/sliding latch system with self-locking and multifunctional operation, according to claim 4, wherein the sliding shoe (62) is retained in a parallel and linear manner by a lever (61) oscillating at one end and which at the other incorporates a bent retaining ratchet, said sliding shoe (62) being released by means of an electromagnet (63) which attracts said retaining lever (61), there existing a permanent magnet (90) for recovery of its locking position.

6. Modular folding/sliding latch system with self-locking and multifunctional operation, according to claim 4, wherein the tilting latch (5″), concealable on closing the door, is crenellated in its lower part, being folded via lateral linkages (64) linked to the first transverse shaft (56) of the latch and to the second transverse shaft (57) of the sliding shoe (65) on which the oscillating retaining lever (61) acts.

7. Modular folding/sliding latch system with self-locking and multifunctional operation, according to claim, according to claim 4, wherein the tilting latch (5″), concealable on closing, crenellated in its lower part, is double folding with a catch for at all times permitting closure of the door via linkages (79) linked to the sliding shoe (62).

8. Modular folding/sliding latch system with self-locking and multifunctional operation, according to claim 4, wherein the latch (5″) offers concealable closing and opening via the convex plane, due to the frame (60) including two curved grooves (77, 78) which permit double folding and its linear transmission via linkages (79); there existing the self-locking lever or rocker arm (80) which is displaced via the interior of the latch (5″) and is assisted by a recovery spring, and a second lever (80′) which links in the same rotating shaft of the self-locking rocker arm (80) and which directly receives the impact against the strike (30), in turn pushing with its pressure spring on said self-locking rocker arm (80), acting on a retaining stop (81) which joins the ends of both linkage pairs (79).

9. Modular folding/sliding latch system with self-locking and multifunctional operation, according to claim 8, wherein two parallel shoes (83) have been provided, linked via one of their end pairs to a base (84) of the casing, and the other ends to a communal lever (82) forming a jointed parallelogram which presses on and linearly displaces a thrust lever (85) which carries an inclined plane (86) at its active end, raising up the rear shaft (87) of the retaining lever (61′) for its release via said inclined plane (86) that said thrust lever (85) incorporates for the purpose.

10. Modular folding/sliding latch system with self-locking and multifunctional operation, according to claim 9, wherein said thrust lever (85) switches a micro-switch which sends a signal for processing when the bar incorporates electromagnetic retention between the sliding shoe (62) and a core (92) in timed control exits.

11. Modular folding/sliding latch system with self-locking and multifunctional operation according to claim 1, wherein the retaining lever (61′) is actuated by the rotation of a follower (89) of the lock on a convexity of forming an extension (88) of said retaining lever (61′).

12. Modular folding/sliding latch system with self-locking and multifunctional operation, according to claim 1, wherein the sliding shoe (62) is assisted by a spring (7) for recovering its original position, and includes a prismatic finish (94) which connects with retaining levers (95) linked to bolts (96) bearing latches (5″) or similar at their locking ends.

13. Modular folding/sliding latch system with self-locking and multifunctional operation, according to claim 1, wherein the rocker arm (12) incorporates two magnets (19, 19a) of different strengths and polarity, which are able to confront each other alternating with a magnet (18) of the retaining lever (16), in the two positions of the latch (5), allowing the introduction of barriers (31) collateral to the sliding shoe (4′).

14. Modular folding/sliding latch system with self-locking and multifunctional operation, according to claim 1, further including a lever (40) with two positioning notches, displaceable by a bulb (27), one mechanically locking the latch and switching a second micro-switch (41) which monitors this state and cuts off the power supply; while the other notch, via an inclined plane, permits the displacement towards the third micro-switch (42) to be incremented for electrical opening, both from the outside and from the inside.

15. Modular folding/sliding latch system with self-locking and multifunctional operation, according to claim 1, further including a presence control integrated into the casing backed onto a front plate (21′) of the strike (30) which consists of a lever (43, 43′″) actuated by a panic handle or square-sectioned panic bar which, in its angular movement, displaces a magnet (44) from a zone of magnetic influence that switches a magnetic switch (45) and in its middle part switches a fourth micro-switch (46); these two signals, duly processed and timed, providing an unequivocal double presence control in emergency exits.

16. Modular folding/sliding latch system with self-locking and multifunctional operation, according to claim 15, wherein the manual openings are electrical, with the handles and bulbs acting on micro-switches duly installed with or without inhibitions.

17. Modular folding/sliding latch system with self-locking and multifunctional operation, according to claim 16, further including a small motor (47) from whose shaft emerges an endless screw (48) which, depending on the direction of rotation via a double steel wire (49) with rotation at one end, displaces a retaining lever (40′) at the other end when sliding on the threads of the screw, locking the latch.

18. Modular folding/sliding latch system with self-locking and multifunctional operation, according to claim 16, further including a coil (50) which attracts a retaining lever (40″) in order to release the latch, becoming is locked in the event of a power supply failure.

19. Modular folding/sliding latch system with self-locking and multifunctional operation, according to claim 16, further including a geared motor (51) for a panic bar with remote opening, associated with some integrated management electronics for control of efforts and travel, which permits manual opening by mechanically acting on a thruster (52) which forces the shaft of the lever (43′″) to rotate assisted by a spring (54) and carrier of a radial arm (55) able to make contact with a retaining lever (40′″), displacing it in the direction of release of the latch.
